(19) United States
(12) Patent Application Publication
(10) Pub. No.: US 2026/0222123 A1
(43) Pub. Date: Jul. 30, 2026

(54) HARQ TRANSMISSION WITH HARQ-ACK CODE BOOK SIZE MISMATCH

(71) Applicant: QUALCOMM Incorporated, San Diego, CA (US)

(72) Inventors: Morteza SOLTANI, San Diego, CA (US); Mostafa KHOSHNEVISAN, San Diego, CA (US); Jing SUN, San Diego, CA (US)

(21) Appl. No.: 19/038,124

(22) Filed: Jan. 27, 2025

(51) Int. Cl. H04L 1/1829; H04L 1/1812; H04L 5/00

(52) U.S. Cl. CPC H04L 1/1861; H04L 1/1812; H04L 5/0051

(57) ABSTRACT

Apparatus, methods, and computer program products for wireless communication are provided. An example method may include receiving, from a network node, at least one downlink control information (DCI) associated with at least one downlink transmission. The example method may further include transmitting, to the network node, an uplink transmission including a hybrid automatic repeat request (HARQ)-acknowledgment (ACK) codebook associated with the at least one DCI, where the uplink transmission is scrambled based on a HARQ-ACK codebook size of the HARQ-ACK codebook.

### TECHNICAL FIELD

The present disclosure relates generally to communication systems, and more particularly, to wireless communication systems with hybrid automatic repeat request (HARQ).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a network node, at least one downlink control information (DCI) associated with at least one downlink transmission. Based at least in part on information stored in the at least one memory, the at least one processor, individually or in any combination, is configured to transmit, to the network node, an uplink transmission including a hybrid automatic repeat request (HARQ)-acknowledgment (ACK) codebook associated with the at least one DCI, where the uplink transmission is scrambled based on a HARQ-ACK codebook size of the HARQ-ACK codebook.

In another aspect of the disclosure, a method, a computer-readable medium, and an apparatus at a UE are provided. Based at least in part on information stored in the at least one memory, the at least one processor, individually or in any combination, is configured to receive, from a network node, at least one DCI associated with at least one downlink transmission. Based at least in part on information stored in the at least one memory, the at least one processor, individually or in any combination, is configured to transmit, to the network node, an uplink transmission including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit, for a UE, at least one DCI associated with at least one downlink transmission. Based at least in part on information stored in the at least one memory, the at least one processor, individually or in any combination, is configured to receive an uplink transmission including a HARQ-ACK codebook associated with the at least one DCI, where the uplink transmission is scrambled based on a HARQ-ACK codebook size of the HARQ-ACK codebook.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit, for a UE, at least one DCI associated with at least one downlink transmission. Based at least in part on information stored in the at least one memory, the at least one processor, individually or in any combination, is configured to receive an uplink transmission including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating downlink control information (DCI) that includes DL grants for physical downlink shared channel (PDSCH) transmissions where last m DL grants may be missed by the UE, in accordance with various aspects of the present disclosure.

FIG. 5 is a diagram illustrating example communications between a network entity and a UE, in accordance with various aspects of the present disclosure.

FIG. 6 is a flowchart of a method of wireless communication, in accordance with various aspects of the present disclosure.

FIG. 7 is a flowchart of a method of wireless communication, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a diagram illustrating an example of a hardware implementation for an example apparatus and/or network entity, in accordance with various aspects of the present disclosure.

FIG. 11 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts.

However, these concepts may be practiced without these specific details. In some instances, well known structures and components are shown in block diagram form in order to avoid obscuring such concepts.

When one or more downlink grants are missed by a user equipment (UE), the UE may use a hybrid automatic repeat request (HARQ)-acknowledgment (ACK) codebook size that is different than the HARQ-ACK codebook size expected by the network. With compression of a HARQ-ACK codebook, different codebook lengths may be encoded into the same length codewords. In such examples, a network node may interpret a decoded codeword based on a different codebook length assumption that the codebook length used by the UE to transmit the HARQ-ACK feedback, and the network node may incorrectly interpret the content of the HARQ-ACK feedback. Aspects provided herein help to avoid incorrect hybrid automatic repeat request (HARQ)-acknowledgment (ACK) codebook size assumptions at network node in case of compression of HARQ feedback by scrambling the UL transmission when different HARQ-ACK CB sizes before compression may result in the same CB length after the compression. The scrambling is done in a manner so that the network node is not able to decode the HARQ-ACK feedback based on an incorrect HARQ-ACK codebook size assumption. With the potential for different CB size assumptions with the compressed HARQ-ACK CB, to the aspects presented herein avoid having the network node decode the HARQ-ACK CB so that further issues can be avoided that may limit HARQ combining for physical downlink shared channel (PDSCH) at later times.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

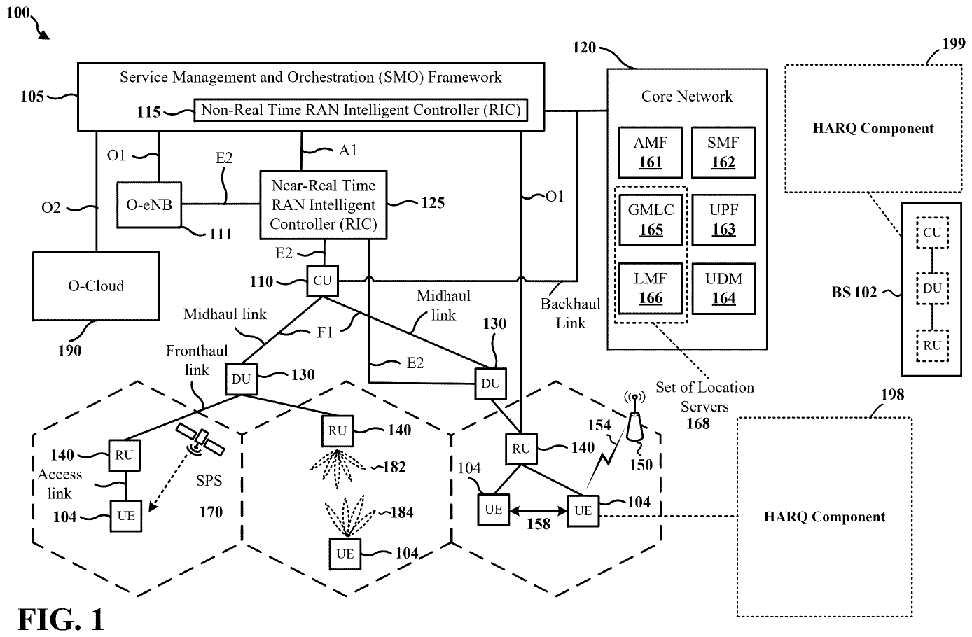

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a HARQ component 198. In some aspects, the HARQ component 198 may be configured to receive, from a network node, at least one DCI associated with at least one downlink transmission. In some aspects, the HARQ component 198 may be further configured to transmit, to the network node, an uplink transmission including a HARQ-ACK codebook associated with the at least one DCI, where the uplink transmission is scrambled based on a HARQ-ACK codebook size of the HARQ-ACK codebook. In some aspects, the HARQ component 198 may be configured to receive, from a network node, at least one DCI associated with at least one downlink transmission. In some aspects, the HARQ component 198 may be further configured to transmit, to the network node, an uplink transmission including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook.

In certain aspects, the base station 102 may include a HARQ component 199. In some aspects, the HARQ component 199 may be configured to transmit, for a UE, at least one DCI associated with at least one downlink transmission. In some aspects, the HARQ component 199 may be further configured to receive an uplink transmission including a HARQ-ACK codebook associated with the at least one DCI, where the uplink transmission is scrambled based on a HARQ-ACK codebook size of the HARQ-ACK codebook. In some aspects, the HARQ component 199 may be configured to transmit, for a UE, at least one DCI associated with at least one downlink transmission. In some aspects, the HARQ component 199 may be further configured to receive an uplink transmission including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

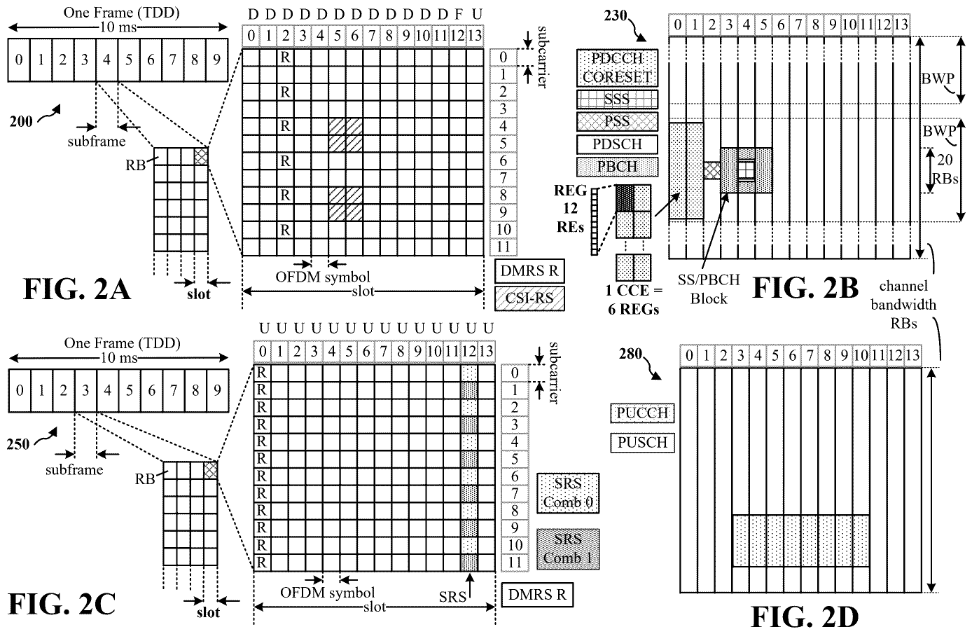

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ*}15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

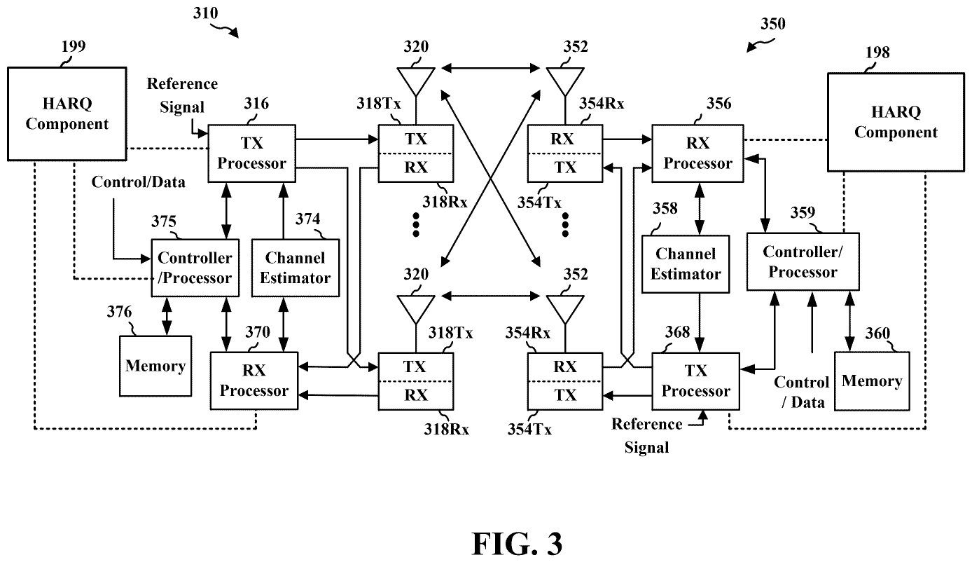

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with HARQ component 198 of FIG. 1.

At least one of the TX processor 316, the RX processor 370, and the controller/processor 375 may be configured to perform aspects in connection with HARQ component 199 of FIG. 1.

In some wireless communication systems, uplink control information (UCI) may carry, or be based on, a HARQ-ACK codebook (CB). The UCI may be channel coded based on its payload size, e.g., and different types of channel coding may be used for UCI having different payload sizes. For example, repetition coding may be used if the payload size of the UCI is smaller than or equal to two bits. Reed Muller (RM) coding may be used if the payload size of the UCI is between three and eleven bits. Polar coding may be used if the payload size of the UCI is greater than twelve bits. Repetition coding is an error-correcting technique in which each bit of data is repeated multiple times (e.g., 3 times or 5 times) to improve reliability. RM coding includes a class of linear error-correcting codes characterized by their structured construction and ability to correct multiple errors. RM codes are parameterized by a tuple (r, m, where r represents the order and m the length of the code's generating polynomial. Polar codes may work by transforming a set of N independent channels into two sets: a first set of channels used for data transmission and a second set of channels frozen to fixed values.

In some wireless communication systems, a lossy or lossless compression scheme may not be defined for compressing the HARQ-ACK CB. However, in some particular use cases, a lossy compression such as spatial bundling may be used where ACK/negative ACK (NACK) of two Transport Blocks (TBs) within a given PDSCH (e.g., for rank greater than four, where PDSCH has 2 TBs) may be bundled.

A HARQ-ACK codebook may include three properties. First, it may have non-uniform distribution of bits. For example, an ACK may be more likely than a NACK due to open loop link adaptation maintaining DL block error rate (BLER) around 10%. Therefore, the probability of ACK (1) is 0.9, whereas the probability of NACK (0) is 0.1. This non-uniform probability makes the HARQ-ACK CB more compressible. Second, the HARQ-ACK codebook may have a correlation among HARQ-ACK bits due to different PDSCHs received at different times, different frequencies, and/or different spatial layers. The consequence, or drawback, of a NACK-to-ACK error (e.g., no HARQ combining for PDSCH is possible after a NACK is mistakenly identified as an ACK) has more of an effect on the communication than an ACK-to-NACK error (e.g., which results in an unnecessary PDSCH retransmissions if an ACK is mistakenly identified as a NACK). Therefore, with compression of a HARQ-ACK CB, it is helpful to avoid NACK-to-ACK errors (e.g., in which a NACK is mistakenly identified as an ACK).

In some aspects, Hoffman codes or entropy codes may be used for loss-less source coding of a HARQ-ACK CB. In some aspects, a bundling scheme (with bundle size b, where b determines the rate-distortion tradeoff) may be used as a lossy compression scheme for HARQ-ACK CB.

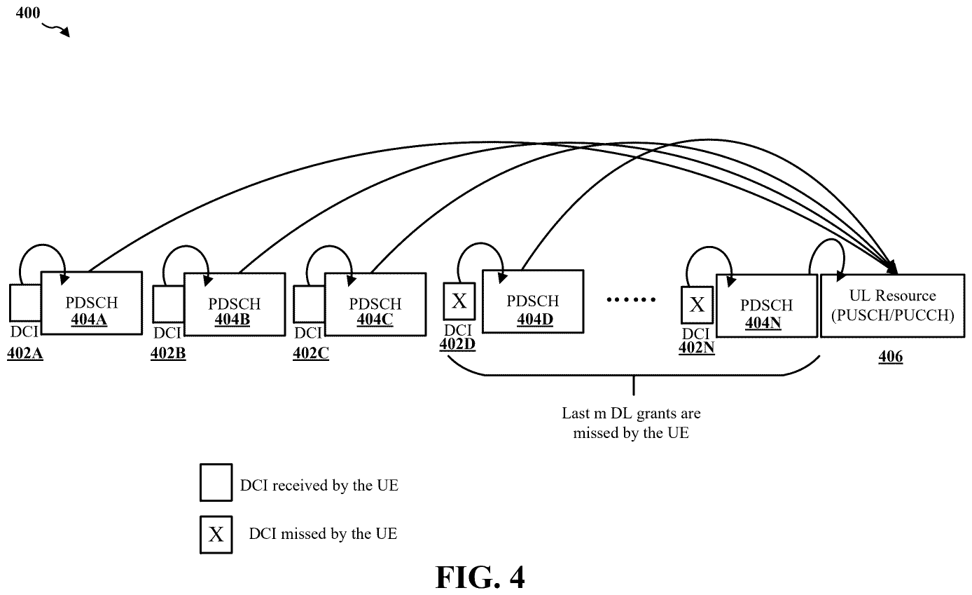

In some wireless communication systems, when one or more DL grants (e.g., the last m DL grants, where m is an integer number of 1 or more) are missed by the UE, the HARQ-ACK CB size used by the UE to send the UCI may be different from the HARQ-ACK CB size expected by the network. For example, FIG. 4 is a diagram 400 illustrating DCI (402A, 402B, 402C, 402D, and 402N) that includes DL grants PDSCH transmissions (404A, 404B, 404C, 404D, and 404N). As shown by the X in DCI 402D and 402N, the UE missed some of the DCI scheduling resources for respective PDSCH transmissions. Therefore, the UE is not aware of the PDSCH transmissions 404D and 404N. As illustrated by the dotted line, there may be any number of missed DCI between the DCI 402D and 402N. In this example, the last m DL grants (e.g., starting at 402D and ending at 402N) are missed by the UE. For example, a first DCI 402A that includes a DL grant for a PDSCH transmission 404A may be received by the UE, and the UE may attempt to receive the scheduled PDSCH (e.g., 404A). A second DCI 402B that includes a DL grant for a PDSCH transmission 404B may be received by the UE, and the UE may attempt to receive the scheduled PDSCH (e.g., 404B). A third DCI 402C that includes a DL grant for a PDSCH transmission 404C may be received by the UE, and the UE may attempt to receive the scheduled PDSCH (e.g., 404C). However, the subsequent DCIs, such as a fourth DCI 402D that includes a DL grant for a PDSCH transmission 404D up to an n^{th} DCI 402N that includes a DL grant for a PDSCH transmission 404N may be missed by the UE. In the example illustrated in FIG. 4, there may be a total of m DCIs missed by the UE. As the UE misses the DCI, the UE is not aware of the scheduled PDSCH, and does not attempt to receive the PDSCH transmissions 404D through 404N. When sending HARQ-ACK feedback, the UE uses a codebook based on a different size (e.g., HARQ-ACK for three PDSCH transmission) that is different than the codebook size that the network will expect (e.g., based on the PDSCH transmissions 404A-404N). In the example illustrated in FIG. 4, the UE may use a HARQ-ACK CB with three bits, such as “101” whereas the network may expect to receive m+3 bits such as

$$“ {\underbrace{1011 … 0.}}_{m + 3 bits} ”$$

In such a scenario, if the UCI (e.g., included in UL resource 406) containing the HARQ-ACK CB is encoded based on RM, then the additional bits that are not sent by the UE as ACK or NACK are decoded as “NACK” by the network, which could lead to retransmissions by the network. However, if the UCI containing the HARQ-ACK CB is encoded based on a Polar code, then the network may not be able to decode HARQ-ACK CB due to a wrong CB size assumption (e.g., if the network is expecting UCI based on a different CB size than was used by the UE).

Additionally, with compression of the HARQ-ACK CB, different CB length may be encoded into the same length codewords. If the network interprets the decoded codeword with a different CB length assumption than the UE used, the network could wrongly interpret the content UCI. For example, in a scenario where the true HARQ-ACK CB is “100110”, e.g., 6 bits, but the last DCI is missed by the UE, the UE is not aware of the scheduled PDSCH. At the UE, the HARQ-ACK CB size before compression is “10011”, e.g., 5 bits. If the bundling scheme is used as a lossy compression scheme, and the bundle size is two, then there may be three bits after compression. For example, the UE may transmit as “001” with the bundling scheme, whereas the compressed version of the true HARQ-ACK CB is “000.” Therefore, if the network decompresses the compressed true HARQ-ACK CB and compares it with the UCI received from the UE, the network may decode “001” as “000011,” whereas the actual compressed version of “000” would be decoded as “000000,” This example illustrates that the mistaken size of the codebook used for the UCI may cause an NACK-to-ACK issue, in which the network mistakenly determines a NACK to be an ACK. This could lead the network to skip a retransmission, although the UE did not receive the scheduled PDSCH.

As a second example, the true HARQ-ACK CB may be “100110”, e.g., 6 bits, but the last DCI may be missed by the UE. Based on the missed DCI, the UE uses a HARQ-ACK CB size, before compression is “10011”, e.g., 5 bits. If the UE uses a lossy compression scheme where the UE sends the number of consecutive ACKs in the HARQ-ACK CB starting from least significant bits (LSB) or most significant bits (MSB), then at the UE, the HARQ-ACK CB before compression is “10011” and the compression scheme results in the UE sending the LSB/MSB indication as well as the number of consecutive ACKs in “10011.” Therefore, the compressed HARQ-ACK CB at UE is “010,” where the first “0” is a LSB indicator and the “10” indicates number of consecutive ACKs starting from the LSB. The compressed version of the actual (e.g., true) HARQ-ACK CB (i.e., “100110”) taking into consideration each of the scheduled PDSCH may be “101” because the number of consecutive ACKs starting from MSB is more than number of consecutive ACKs starting from LSB. Therefore, if the network decompresses the compressed version of the true HARQ-ACK CB with the one that is sent via UE, the network may decode the received “010” as “000011” where the true HARQ-ACK CB based on the correct number of scheduled PDSCH would be “101” that decodes to “100000.” By decoding “000011” instead of “100000,” the network has both an NACK-to-ACK circumstance (in which a NACK is mistaken to be an ACK) and an ACK-to-NACK circumstance (in which an ACK is mistakenly identified as a NACK).

Aspects provided herein help to avoid incorrect hybrid automatic repeat request (HARQ)-acknowledgment (ACK) codebook size assumptions at network node in case of compression of HARQ feedback by scrambling the UL transmission when different HARQ-ACK CB sizes before compression may result in the same CB length after the compression. The scrambling is done in a manner so that the network node is not able to decode the HARQ-ACK feedback based on an incorrect HARQ-ACK codebook size assumption. With the potential for different CB size assumptions with the compressed HARQ-ACK CB, to the aspects presented herein avoid having the network node decode the HARQ-ACK CB so that further issues can be avoided that may limit HARQ combining for physical downlink shared channel (PDSCH) at later times.

In some aspects, on the UL, the UE may scramble the UCI transmission in a way that the network is not able to decode the UCI if the network is expecting (or using) a different codebook size than the HARQ-ACK codebook used by the UE to generate the UCI. As an example, the UE may scramble the UCI based on the HARQ-ACK CB size. If the network has a different codebook size assumption (e.g., based on having transmitted DCI scheduling DL transmissions that the UE did not receive), the network is not able to decode the UCI. This helps the network to avoid making decisions based on inaccurate information. In some aspects, if the UCI containing the HARQ-ACK CB is transmitted in a PUCCH transmission, the UE may select the PUCCH DMRS sequence for the PUCCH transmission based on the HARQ-ACK CB size for the PUCCH transmission. In some aspects, the selection of the DMRS sequence based on the HARQ-ACK CB size may be used for PUCCH formats 1 to 4. Fo the PUCCH formats, PUCCH format 1 is used for transmitting smaller amounts of UCI, such as a single-bit or multi-bit ACK/NACK information, and occupies a single symbol. PUCCH format 2 supports slightly larger UCI payloads, using multiple symbols and a single RB, making it suitable for lower payload. PUCCH format 3 is used for larger UCI payloads and spans multiple symbols and multiple RBs, providing more capacity. PUCCH Format 4 is used for UCI payloads that are larger than format 3 payloads and offers enhanced time and frequency diversity by using multiple symbols and multiple RBs with beamforming support.

In some aspects, different HARQ-ACK CB sizes may be mapped to different base sequences that may be used for a DM-RS sequence. In some aspects, to determine the base sequence used for the uplink transmission, a HARQ-ACK CB size may be mapped to a sequence group u or a sequence index within a group v, or both. For Zadoff-Chu sequence r̅_{u,v}(n) used for format 3 and 4 (as well as format 0 and 1), u and v determine the base sequence, where 30 different sequence groups where u∈{0,1, . . . ,29} indexes a sequence group, and v∈{0,1} indexes the sequences within a group. The number of sequences per group depends on the sequence length. For sequences of length longer than 72, there are two sequences per group; otherwise, there is one sequence per group and v=0.

In some aspects, different HARQ-ACK CB sizes may be mapped to different cyclic shifts used for the DM-RS sequence. In some aspects, different HARQ-ACK CB sizes may be mapped to different hopping identifiers (IDs) used for the DM-RS sequence. For sequence or group hopping, or for cyclic shift hopping, hopping ID may be an ID used to determine initialization for a pseudo-random sequence that is used in the hopping formula (which the hopping formula determines the base sequence or the cyclic shift). In some aspects, different HARQ-ACK CB sizes may be mapped to different IDs that determines initialization used for the DM-RS sequence. The IDs may be scrambling IDs, for example. The initialization may also be a function of time (e.g., based on a symbol or slot number) in addition to the ID, and may determine a seed for a pseudo-random sequence that determines the DM-RS sequence.

In some aspects, if the UE sends the UCI in a format 0 PUCCH transmission, the PUCCH transmission may be transmitted without DM-RS. In this example, the UCI content may be encoded based on the cyclic shift of the sequence, the UE may select the sequence as a function of HARQ-ACK CB size. In some aspects, if the UCI containing the HARQ-ACK CB is transmitted in a PUSCH transmission (e.g., with RM, Polar, or repetition codec), the UCI codeword (e.g., the entire UCI codeword) may be scrambled based on a scrambling sequence that depends on the HARQ-ACK CB size. In some aspects, if the UE transmits the UCI containing the compressed HARQ-ACK on PUCCH or PUSCH (e.g., in a PUCCH transmission or a PUSCH transmission) and Polar code is used, the cyclic redundancy check (CRC) may be scrambled by a scrambling sequence that is based on the HARQ-ACK CB size.

HARQ-ACK CB size mismatch may occur based on the UE missing the last m DCIs scheduling PDSCH for which the UE is to send the HARQ-ACK feedback. In some wireless communication systems, missing m (where m<4) consecutive DCIs in the middle_(and not at the end) may be not problematic because downlink assignment indicator (DAI) may be used by the UE to determine that it has missed the m consecutive DCIs in the middle by the DAI field in the last DCI. The DAI is a control field used for managing the HARQ process for downlink transmissions that may be transmitted via PUCCH or PUSCH and may serve as a counter to indicate the sequence number of downlink transmissions for which the UE is providing ACK/NACK. When m≥4, even missing the m DCIs in the middle may be problematic. By scrambling UE's UL transmissions based on the HARQ-ACK CB size, the network node is able to decode UL transmission due to the scrambling, which reduces the HARQ related issues caused by missing the DCIs. For example, as the network node does not decode the UCI due to the scrambling based on a different codebook size than the network node is expecting, the network node does not misinterpret the UCI from the UE (e.g., does not make NACK-to-ACK or ACK-to-NACK misidentifications).

Some aspects provided herein additionally facilitate a network node to determine that the last m DCIs are missed by the UE by enabling protection against missing the last m DCIs via choosing different scrambling sequences (or scrambling IDs) to scramble the UE's transmission. For example, there may be two different scrambling sequences (or scrambling IDs), i.e., whether the HARQ-ACK CB size before compression is “even” or “odd.” More generally, to handle the cases that last m DCIs are missed, there may be m+1 scrambling IDs with a mathematical (e.g., modular) m+1 operation on the HARQ-ACK CB size before compression at the UE. The UE may select the scrambling sequence ID out of m+1 possible scrambling sequences based on a modular m+1 operation on the HARQ-ACK CB size before compression at the UE. In some aspects, the parameter m which provides protection against the quantity of last m missing DCIs may be RRC configured for the or may be defined in a wireless standard (e.g., and known to the UE and the network node without signaling). In some aspects, the scrambling sequences with their corresponding IDs may be RRC configured or defined (e.g., in a wireless standard).

In some aspects, the quantity of scrambling sequences (or IDs) may be further adjusted. For example, if the HARQ-ACK CB size at the UE before compression is “K” bits and the HARQ-ACK CB size at the UE after compression is “L” bits, where L<K, for a particular compression scheme/parameter, the UE may calculate the number of possible codeword lengths after compression based on {K, K+1, . . . , K+m}, so that the total possibilities is x≤m+1 with lengths {L₁, L₂, . . . , Lₓ}. The worse-case scenario is when x=1, then m+1 scrambling sequences IDs may be used. For length L (CB size after compression), it may be calculated how many of the original length {K, K+1, . . . , K+m} (before compression) will be mapped to L and denote that number as s. If x=1 then s=m+1 (worst case scenario), if 1<x≤m+1 then s<m+1. The quantity of s will be the number of scrambling sequences used to protect against up to the m last missing DCIs.

For example, the UE might have missed up to the last 3 DCIs and the possible HARQ-ACK CB lengths before compression are K∈{5,6,7,8} bits, if a bundling scheme with bundle size 2 is used at the UE for HARQ-ACK CB compression, protection against missing up to the last 3 DCIs by the UE may be used. Therefore, two scrambling sequence IDs may be used because two sets of CB lengths before compression are mapped to the same CB length after compression, i.e., K∈{5,6}→L₁=3 and K∈{7,8}→L₂=4.

In a first example scenario, the UE may have missed all the 3 last DCIs, and the HARQ-ACK CB is “10011”, then the UE sends “001” after compressing the HARQ-ACK CB while the network node may expect to receive a 4-bit HARQ-ACK CB. In such a scenario based on aspects provided herein, when there is a CB size mismatch at UE and network node, either the network node does not decode (if Polar code are used) or network node decodes properly (if RM is used), and there may be no issue.

In a second example scenario, if the UE has missed the last 2 DCIs out of the 3 last DCIs, and the HARQ-ACK CB is “100110”, then the UE sends “000” after compressing the HARQ-ACK CB while the network node may expect to receive a 4-bit HARQ-ACK CB. In such a scenario based on aspects provided herein, when there is a CB size mismatch at UE and network node, either the network node does not decode (if Polar code is used) or network node decodes properly (if RM is used), and there may be no issue.

In a third example scenario, the UE has missed the last DCIs out of the 3 last DCIs, and the HARQ-ACK CB is “1001101”, then the UE sends “0001” after compressing the HARQ-ACK CB and the network node may expect to receive a 4-bit HARQ-ACK CB, then the network node may have ambiguity on what the actual CB size is before the compression without aspects provided herein. Based on aspects provided herein, because the network node may assume that actual HARQ-ACK CB size before compression at the UE is 8 bits and may decompress “0001” into “00000011” which contains wrong information if it is decoded, the UE may scramble its transmission based on a scrambling sequence ID that corresponds to an “odd” CB size to avoid such an issue. Additionally, if the network node assumes that actual HARQ-ACK CB size before compression at the UE is 7 bits, then the network node may pick the correct scrambling sequence ID and then decompresses “0001” into “0000001” and the feature of HARQ-ACK CB compression may be maintained (i.e., avoiding NACK to ACK errors).

For a network that receives a scrambled UL transmission by the UE, the network may assume the HARQ CB to be all NACK if the network node is not able to reliably decode the scrambled UL transmission using a scrambling sequence ID that is derived based on the assumed HARQ-ACK CB size by the network (e.g., if the network node attempts to decode the UCI based on a different HARQ-ACK CB size assumption than the HARQ-ACK CB size used by the UE to generate the UCI). In some aspects, the network may use multiple hypothesis for blind decoding of the HARQ-ACK CB size based on different HARQ-ACK CB sizes, and the corresponding scrambling sequences.

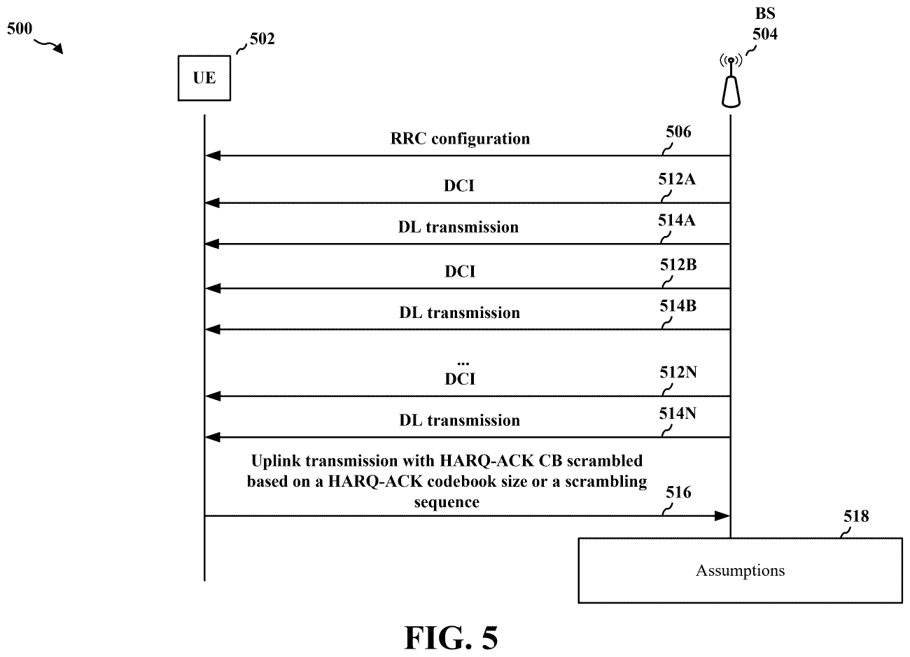

FIG. 5 is a diagram 500 illustrating example communications between a network node 504 and a UE 502, in accordance with various aspects of the present disclosure described herein. As illustrated in FIG. 5, the UE 502 may receive, from the network node 504, at least one DCI including DCI 512A, DCI 512B, . . . , DCI 512N associated with at least one DL transmission including DL transmission 514A, DL transmission 514B, . . . , DL transmission 514N. The at least one DCI may schedule the at least one DL transmission (e.g., PDSCH). The UE 502 may transmit, to the network node 504, an uplink transmission 516 including a HARQ-ACK codebook (e.g., UCI based on a HARQ-ACK codebook) associated with the at least one DCI, where the uplink transmission is scrambled based on a HARQ-ACK codebook size of the HARQ-ACK codebook or where the uplink transmission is scrambled based on a scrambling sequence from a set of scrambling sequences (e.g., the scrambling sequence is selected based on a mathematical operation based on a quantity of the set of scrambling sequences or a HARQ-ACK codebook size of the HARQ-ACK codebook). A configuration of the set of scrambling sequences or a configuration of the set of scrambling sequences may be configured via RRC configuration 506 or configured without signaling.

At 518, the network node 504 may assume the HARQ CB to be all NACK if the network node does not reliably decode the scrambled UL transmission using a scrambling sequence ID that is derived based on the assumed HARQ-ACK CB size by the network. In some aspects, the network may use multiple hypothesis to attempt blind decoding of the HARQ-ACK transmission (e.g., UCI based on a HARQ-ACK CB size). The multiple blind decoding hypotheses may be based on different HARQ-ACK CB sizes and the corresponding scrambling sequences.

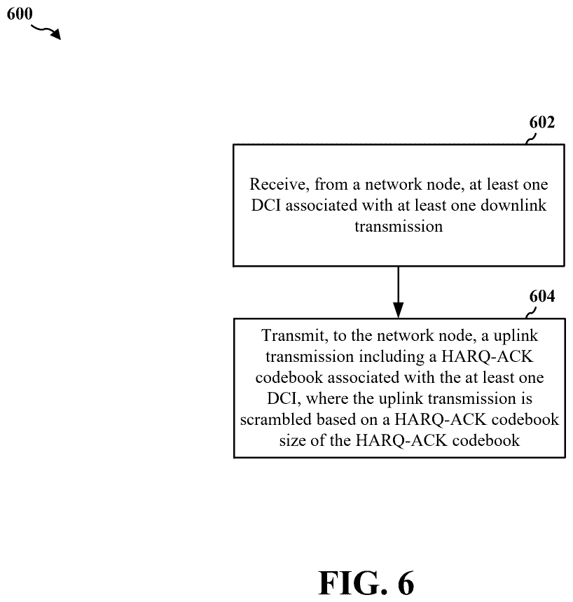

FIG. 6 is a flowchart 600 of a method of wireless communication. The method may be performed by a UE (e.g., the UE 104, the UE 502; the apparatus 1004). The method may mitigate issues caused by wrong HARQ-ACK CB size assumption at network node in case of compression of HARQ feedback by making sure that the network node may not be able to decode the HARQ-ACK feedback by scrambling the UL transmission when different HARQ-ACK CB sizes before compression results in the same CB length after the compression.

At 602, the UE may receive, from a network node, at least one DCI associated with at least one downlink transmission. For example, the UE 502 may receive, from a network node 504, at least one DCI (e.g., 512A, 512B, . . . 512N) associated with at least one downlink transmission (e.g., 514A, 514B, . . . 514N). In some aspects, 602 may be performed by HARQ component 198.

At 604, the UE may transmit, to the network node, an uplink transmission including a HARQ-ACK codebook associated with the at least one DCI, where the uplink transmission is scrambled based on a HARQ-ACK codebook size of the HARQ-ACK codebook. For example, the UE 502 may transmit, to the network node 504, an uplink transmission 516 including a HARQ-ACK codebook associated with the at least one DCI, where the uplink transmission is scrambled based on a HARQ-ACK codebook size of the HARQ-ACK codebook. In some aspects, 604 may be performed by HARQ component 198.

In some aspects, the uplink transmission is a physical uplink control channel (PUCCH) transmission, and where a PUCCH demodulation reference signal (DM-RS) associated with the PUCCH transmission is based on a size associated with the HARQ-ACK codebook.

In some aspects, the size associated with the HARQ-ACK codebook is mapped to a particular sequence in a set of sequences, where the set of sequences is associated with the PUCCH DM-RS.

In some aspects, the size associated with the HARQ-ACK codebook is mapped to a particular cyclic shift in a set of cyclic shifts, where the set of cyclic shifts is associated with the PUCCH DM-RS.

In some aspects, the size associated with the HARQ-ACK codebook is mapped to a particular hopping ID in a set of hopping IDs, where the set of hopping IDs is associated with the PUCCH DM-RS.

In some aspects, the size associated with the HARQ-ACK codebook is mapped to a particular initialization ID in a set of initialization IDs, where the set of initialization IDs is associated with an initialization of the PUCCH DM-RS, and where the initialization is further based on a time associated with the PUCCH DM-RS.

In some aspects, the uplink transmission is a physical uplink control channel (PUCCH) transmission without a PUCCH demodulation reference signal (DM-RS), where a sequence associated with the PUCCH transmission is based on a size of the HARQ-ACK codebook.

In some aspects, the uplink transmission is a physical uplink shared channel (PUSCH) transmission, and where an uplink control information (UCI) codeword associated with the PUSCH transmission that includes the HARQ-ACK codebook is scrambled based on a scrambling sequence that depends on a size associated with the HARQ-ACK codebook.

In some aspects, an uplink control information (UCI) codeword associated with the uplink transmission that includes the HARQ-ACK codebook is based on a polar codec, and where a cyclic redundancy check associated with the UCI codeword is scrambled based on a scrambling sequence that depends on a size associated with the HARQ-ACK codebook.

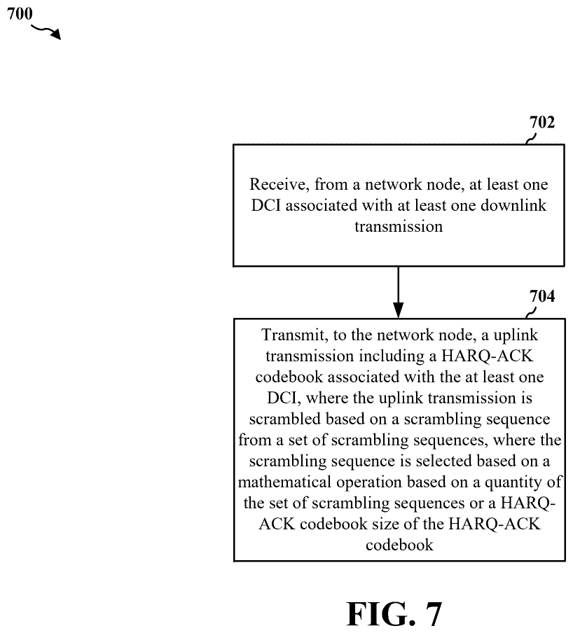

FIG. 7 is a flowchart 700 of a method of wireless communication. The method may be performed by a UE (e.g., the UE 104, the UE 502; the apparatus 1004). The method may mitigate issues caused by wrong HARQ-ACK CB size assumption at network node in case of compression of HARQ feedback by making sure that the network node may not be able to decode the HARQ-ACK feedback by scrambling the UL transmission when different HARQ-ACK CB sizes before compression results in the same CB length after the compression.

At 702, the UE may receive, from a network node, at least one DCI associated with at least one downlink transmission. For example, the UE 502 may receive, from a network node 504, at least one DCI (e.g., 512A, 512B, . . . 512N) associated with at least one downlink transmission (e.g., 514A, 514B, . . . 514N). In some aspects, 702 may be performed by HARQ component 198.

At 704, the UE may transmit, to the network node, an uplink transmission including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook. For example, the UE 502 may transmit, to the network node, an uplink transmission 516 including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook. In some aspects, 704 may be performed by HARQ component 198.

In some aspects, the mathematical operation is a modular operation before compression, and where the quantity of the set of scrambling sequences is equal to the HARQ-ACK codebook size of the HARQ-ACK codebook plus one. In some aspects, the UE may receive, via a radio resource control (RRC) signaling, a configuration of the set of scrambling sequences. In some aspects, a configuration of the set of scrambling sequences is configured without signaling from the network node. In some aspects, the UE may receive, via a radio resource control (RRC) signaling, a configuration of the set of scrambling sequences. In some aspects, a configuration of the set of scrambling sequences is configured without signaling from the network node.

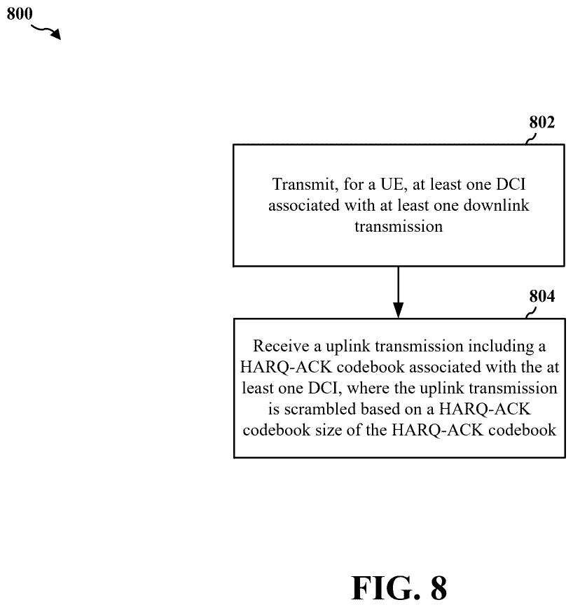

FIG. 8 is a flowchart 800 of a method of wireless communication. The method may be performed by a network node (e.g., the base station 102, the network node 504, the network entity 1002, the network entity 1102). The method may mitigate issues caused by wrong HARQ-ACK CB size assumption at network node in case of compression of HARQ feedback by making sure that the network node may not be able to decode the HARQ-ACK feedback by scrambling the UL transmission when different HARQ-ACK CB sizes before compression results in the same CB length after the compression.

At 802, the network node may transmit, for a UE, at least one DCI associated with at least one downlink transmission. For example, the network node 504 may transmit, for a UE, at least one DCI (e.g., 512A, 512B, . . . 512N) associated with at least one downlink transmission (e.g., 514A, 514B, . . . 514N). In some aspects, 802 may be performed by HARQ component 199.

At 804, the network node may receive an uplink transmission including a HARQ-ACK codebook associated with the at least one DCI, where the uplink transmission is scrambled based on a HARQ-ACK codebook size of the HARQ-ACK codebook. For example, the network node 504 may receive an uplink transmission 516 including a HARQ-ACK codebook associated with the at least one DCI, where the uplink transmission is scrambled based on a HARQ-ACK codebook size of the HARQ-ACK codebook. In some aspects, 804 may be performed by HARQ component 199.

In some aspects, the uplink transmission is a physical uplink control channel (PUCCH) transmission, and where a PUCCH demodulation reference signal (DM-RS) associated with the PUCCH transmission is based on a size associated with the HARQ-ACK codebook.

In some aspects, the size associated with the HARQ-ACK codebook is mapped to a particular sequence in a set of sequences, where the set of sequences is associated with the PUCCH DM-RS.

In some aspects, the size associated with the HARQ-ACK codebook is mapped to a particular cyclic shift in a set of cyclic shifts, where the set of cyclic shifts is associated with the PUCCH DM-RS.

In some aspects, the size associated with the HARQ-ACK codebook is mapped to a particular hopping ID in a set of hopping IDs, where the set of hopping IDs is associated with the PUCCH DM-RS.

In some aspects, the size associated with the HARQ-ACK codebook is mapped to a particular initialization ID in a set of initialization IDs, where the set of initialization IDs is associated with an initialization of the PUCCH DM-RS, and where the initialization is further based on a time associated with the PUCCH DM-RS.

In some aspects, the uplink transmission is a physical uplink control channel (PUCCH) transmission without a PUCCH demodulation reference signal (DM-RS), where a sequence associated with the PUCCH transmission is based on a size of the HARQ-ACK codebook.

In some aspects, the uplink transmission is a physical uplink shared channel (PUSCH) transmission, and where an uplink control information (UCI) codeword associated with the PUSCH transmission that includes the HARQ-ACK codebook is scrambled based on a scrambling sequence that depends on a size associated with the HARQ-ACK codebook.

In some aspects, an uplink control information (UCI) codeword associated with the uplink transmission that includes the HARQ-ACK codebook is based on a polar codec, and where a cyclic redundancy check associated with the UCI codeword is scrambled based on a scrambling sequence that depends on a size associated with the HARQ-ACK codebook.

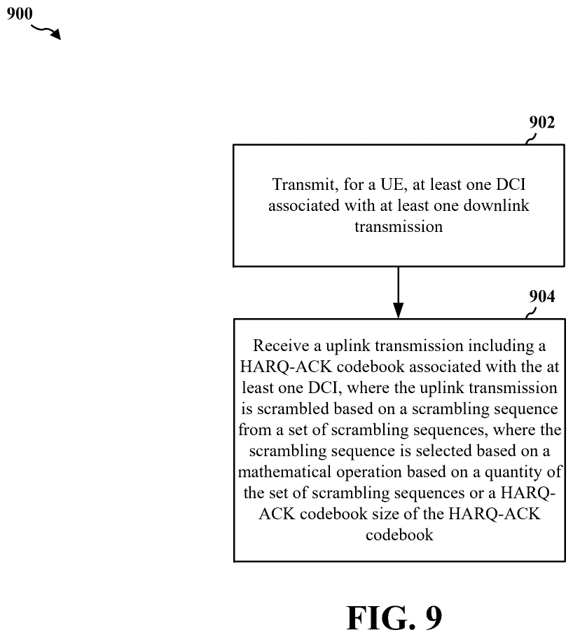

FIG. 9 is a flowchart 900 of a method of wireless communication. The method may be performed by a network node (e.g., the base station 102, the network node 504, the network entity 1002, the network entity 1102). The method may mitigate issues caused by wrong HARQ-ACK CB size assumption at network node in case of compression of HARQ feedback by making sure that the network node may not be able to decode the HARQ-ACK feedback by scrambling the UL transmission when different HARQ-ACK CB sizes before compression results in the same CB length after the compression.

At 902, the network node may transmit, for a UE, at least one DCI associated with at least one downlink transmission. For example, the network node 504 may transmit, for a UE 502, at least one DCI (e.g., 512A, 512B, . . . 512N) associated with at least one downlink transmission (e.g., 514A, 514B, . . . 514N). In some aspects, 902 may be performed by HARQ component 199.

At 904, the network node may receive an uplink transmission including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook. For example, the network node 504 may receive an uplink transmission 516 including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook. In some aspects, 904 may be performed by HARQ component 199.

In some aspects, the mathematical operation is a modular operation before compression, and where the quantity of the set of scrambling sequences is equal to the HARQ-ACK codebook size of the HARQ-ACK codebook plus one. In some aspects, the network node may transmit, via a radio resource control (RRC) signaling, a configuration of the set of scrambling sequences. In some aspects, a configuration of the set of scrambling sequences is configured without signaling. In some aspects, the network node may transmit, via a radio resource control (RRC) signaling, a configuration of the set of scrambling sequences. In some aspects, a configuration of the set of scrambling sequences is configured without signaling.

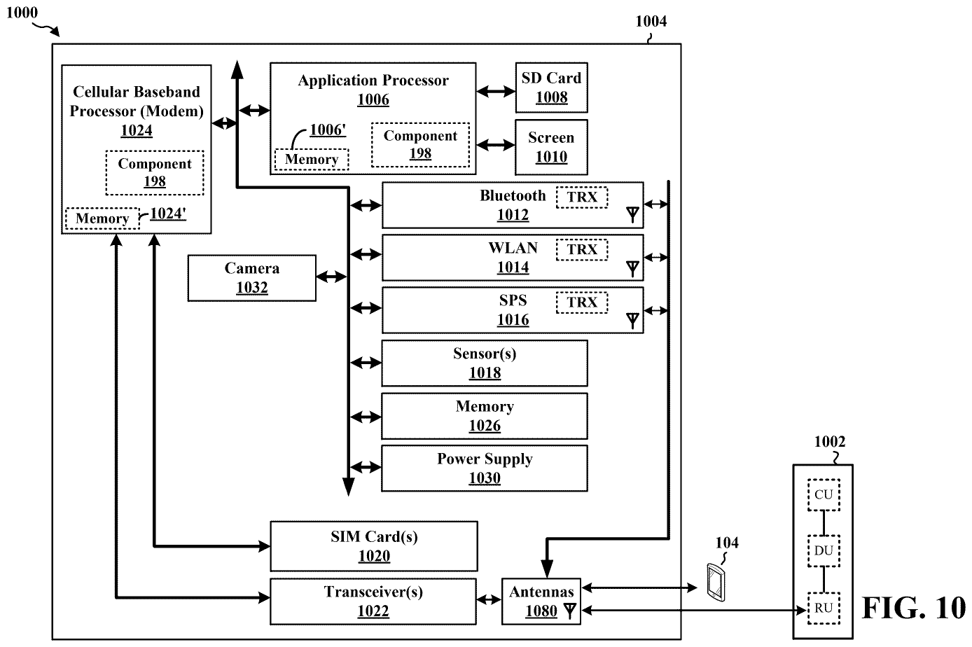

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the HARQ component 198 may be configured to receive, from a network node, at least one DCI associated with at least one downlink transmission. In some aspects, the HARQ component 198 may be further configured to transmit, to the network node, an uplink transmission including a HARQ-ACK codebook associated with the at least one DCI, where the uplink transmission is scrambled based on a HARQ-ACK codebook size of the HARQ-ACK codebook. In some aspects, the HARQ component 198 may be configured to receive, from a network node, at least one DCI associated with at least one downlink transmission. In some aspects, the HARQ component 198 may be further configured to transmit, to the network node, an uplink transmission including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook. The HARQ component 198, and/or the apparatus 1004 may be further configured to perform any of the aspects described in connection with the flowchart in FIGS. 6 and/or 7, and/or performed by the UE in the communication flow in FIG. 5. The HARQ component 198 may be within the cellular baseband processor(s) 1024, the application processor(s) 1006, or both the cellular baseband processor(s) 1024 and the application processor(s) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for receiving, from a network node, at least one downlink control information (DCI) associated with at least one downlink transmission. In some aspects, the apparatus 1004 may include means for transmitting, to the network node, an uplink transmission including a hybrid automatic repeat request (HARQ)-acknowledgment (ACK) codebook associated with the at least one DCI, where the uplink transmission is scrambled based on a HARQ-ACK codebook size of the HARQ-ACK codebook. In some aspects, the apparatus 1004 may include means for receiving, from a network node, at least one downlink control information (DCI) associated with at least one downlink transmission. In some aspects, the apparatus 1004 may include means for receiving, from a network node, at least one downlink control information (DCI) associated with at least one downlink transmission. In some aspects, the apparatus 1004 may include means for transmitting, to the network node, an uplink transmission including a hybrid automatic repeat request (HARQ)-acknowledgment (ACK) codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook. In some aspects, the apparatus 1004 may include means for receiving, via a radio resource control (RRC) signaling, a configuration of the set of scrambling sequences. The apparatus may further include means for performing any of the aspects described in connection with the flowchart in FIGS. 6 and/or 7, and/or performed by the UE in the communication flow in FIG. 5. In some aspects, the apparatus 1004 may include means for receiving, via a radio resource control (RRC) signaling, a configuration of the set of scrambling sequences. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

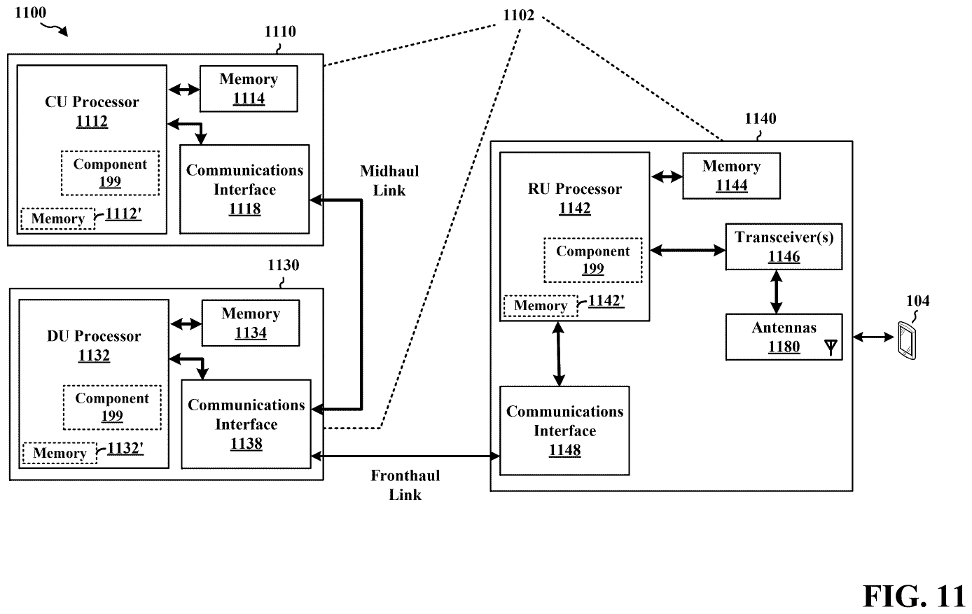

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the HARQ component 199 may be configured to transmit, for a UE, at least one DCI associated with at least one downlink transmission. In some aspects, the HARQ component 199 may be further configured to receive an uplink transmission including a HARQ-ACK codebook associated with the at least one DCI, where the uplink transmission is scrambled based on a HARQ-ACK codebook size of the HARQ-ACK codebook. In some aspects, the HARQ component 199 may be configured to transmit, for a UE, at least one DCI associated with at least one downlink transmission. In some aspects, the HARQ component 199 may be further configured to receive an uplink transmission including a HARQ-ACK codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook. The HARQ component 199 or the network entity may be further configured to any of the aspects described in connection with the flowchart in FIGS. 8 and/or 9, and/or performed by the network node in the communication flow in FIG. 5. The HARQ component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for transmitting, for a user equipment (UE), at least one downlink control information (DCI) associated with at least one downlink transmission. In some aspects, the network entity 1102 may include means for receiving an uplink transmission including a hybrid automatic repeat request (HARQ)-acknowledgment (ACK) codebook associated with the at least one DCI, where the uplink transmission is scrambled based on a HARQ-ACK codebook size of the HARQ-ACK codebook. In some aspects, the network entity 1102 may include means for transmitting, for a user equipment (UE), at least one downlink control information (DCI) associated with at least one downlink transmission. In some aspects, the network entity 1102 may include means for receiving an uplink transmission including a hybrid automatic repeat request (HARQ)-acknowledgment (ACK) codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook. In some aspects, the network entity 1102 may include means for transmitting, via a radio resource control (RRC) signaling, a configuration of the set of scrambling sequences. In some aspects, the network entity 1102 may include means for transmitting, via a radio resource control (RRC) signaling, a configuration of the set of scrambling sequences. The network entity 1102 may further include means for performing any of the aspects described in connection with the flowchart in FIGS. 8 and/or 9, and/or performed by the network node in the communication flow in FIG. 5. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, and based at least in part on information stored in the at least one memory, the at least one processor is configured to: receive, from a network node, at least one downlink control information (DCI) associated with at least one downlink transmission; and transmit, to the network node, an uplink transmission including a hybrid automatic repeat request (HARQ)-acknowledgment (ACK) codebook associated with the at least one DCI, where the uplink transmission is scrambled based on a HARQ-ACK codebook size of the HARQ-ACK codebook.

Aspect 2 is the apparatus of aspect 1, where the uplink transmission is a physical uplink control channel (PUCCH) transmission, and where a PUCCH demodulation reference signal (DM-RS) associated with the PUCCH transmission is based on a size associated with the HARQ-ACK codebook.

Aspect 3 is the apparatus of aspect 2, where the size associated with the HARQ-ACK codebook is mapped to a particular sequence in a set of sequences, where the set of sequences is associated with the PUCCH DM-RS.

Aspect 4 is the apparatus of any of aspects 2-3, where the size associated with the HARQ-ACK codebook is mapped to a particular cyclic shift in a set of cyclic shifts, where the set of cyclic shifts is associated with the PUCCH DM-RS.

Aspect 5 is the apparatus of any of aspects 2-4, where the size associated with the HARQ-ACK codebook is mapped to a particular hopping identifier (ID) in a set of hopping IDs, where the set of hopping IDs is associated with the PUCCH DM-RS.

Aspect 6 is the apparatus of any of aspects 2-5, where the size associated with the HARQ-ACK codebook is mapped to a particular initialization identifier (ID) in a set of initialization IDs, where the set of initialization IDs is associated with an initialization of the PUCCH DM-RS, and where the initialization is further based on a time associated with the PUCCH DM-RS.

Aspect 7 is the apparatus of aspect 1, where the uplink transmission is a physical uplink control channel (PUCCH) transmission without a PUCCH demodulation reference signal (DM-RS), where a sequence associated with the PUCCH transmission is based on a size of the HARQ-ACK codebook.

Aspect 8 is the apparatus of aspect 1, where the uplink transmission is a physical uplink shared channel (PUSCH) transmission, and where an uplink control information (UCI) codeword associated with the PUSCH transmission that includes the HARQ-ACK codebook is scrambled based on a scrambling sequence that depends on a size associated with the HARQ-ACK codebook.

Aspect 9 is the apparatus of any of aspects 1-8, where an uplink control information (UCI) codeword associated with the uplink transmission that includes the HARQ-ACK codebook is based on a polar codec, and where a cyclic redundancy check associated with the UCI codeword is scrambled based on a scrambling sequence that depends on a size associated with the HARQ-ACK codebook.

Aspect 10 is an apparatus for wireless communication at a user equipment (UE), including: at least one memory; and at least one processor coupled to the at least one memory, and based at least in part on information stored in the at least one memory, the at least one processor is configured to: receive, from a network node, at least one downlink control information (DCI) associated with at least one downlink transmission; and transmit, to the network node, an uplink transmission including a hybrid automatic repeat request (HARQ)-acknowledgment (ACK) codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook.

Aspect 11 is the apparatus of aspect 10, where the mathematical operation is a modular operation before compression, and where the quantity of the set of scrambling sequences is equal to the HARQ-ACK codebook size of the HARQ-ACK codebook plus one.

Aspect 12 is the apparatus of any of aspects 10-11, where the at least one processor is further configured: receive, via a radio resource control (RRC) signaling, a configuration of the set of scrambling sequences.

Aspect 13 is the apparatus of aspect 10, where a configuration of the set of scrambling sequences is configured without signaling from the network node.

Aspect 14 is the apparatus of aspect 10, where the at least one processor is further configured: receive, via a radio resource control (RRC) signaling, a configuration of the set of scrambling sequences.

Aspect 15 is the apparatus of aspect 1-14, where a configuration of the set of scrambling sequences is configured without signaling from the network node.

Aspect 16 is an apparatus for wireless communication at a network node, including: at least one memory; and at least one processor coupled to the at least one memory, and based at least in part on information stored in the at least one memory, the at least one processor is configured to: transmit, for a user equipment (UE), at least one downlink control information (DCI) associated with at least one downlink transmission; and receive an uplink transmission including a hybrid automatic repeat request (HARQ)-acknowledgment (ACK) codebook associated with the at least one DCI, where the uplink transmission is scrambled based on a HARQ-ACK codebook size of the HARQ-ACK codebook.

Aspect 17 is the apparatus of aspect 16, where the uplink transmission is a physical uplink control channel (PUCCH) transmission, and where a PUCCH demodulation reference signal (DM-RS) associated with the PUCCH transmission is based on a size associated with the HARQ-ACK codebook.

Aspect 18 is the apparatus of aspect 17, where the size associated with the HARQ-ACK codebook is mapped to a particular sequence in a set of sequences, where the set of sequences is associated with the PUCCH DM-RS.

Aspect 19 is the apparatus of any of aspects 17-18, where the size associated with the HARQ-ACK codebook is mapped to a particular cyclic shift in a set of cyclic shifts, where the set of cyclic shifts is associated with the PUCCH DM-RS.

Aspect 20 is the apparatus of any of aspects 17-19, where the size associated with the HARQ-ACK codebook is mapped to a particular hopping identifier (ID) in a set of hopping IDs, where the set of hopping IDs is associated with the PUCCH DM-RS.

Aspect 21 is the apparatus of any of aspects 17-20, where the size associated with the HARQ-ACK codebook is mapped to a particular initialization identifier (ID) in a set of initialization IDs, where the set of initialization IDs is associated with an initialization of the PUCCH DM-RS, and where the initialization is further based on a time associated with the PUCCH DM-RS.

Aspect 22 is the apparatus of any of aspects 16-21, where the uplink transmission is a physical uplink control channel (PUCCH) transmission without a PUCCH demodulation reference signal (DM-RS), where a sequence associated with the PUCCH transmission is based on a size of the HARQ-ACK codebook.

Aspect 23 is the apparatus of any of aspects 16-22, where the uplink transmission is a physical uplink shared channel (PUSCH) transmission, and where an uplink control information (UCI) codeword associated with the PUSCH transmission that includes the HARQ-ACK codebook is scrambled based on a scrambling sequence that depends on a size associated with the HARQ-ACK codebook.

Aspect 24 is the apparatus of any of aspects 16-23, where an uplink control information (UCI) codeword associated with the uplink transmission that includes the HARQ-ACK codebook is based on a polar codec, and where a cyclic redundancy check associated with the UCI codeword is scrambled based on a scrambling sequence that depends on a size associated with the HARQ-ACK codebook.

Aspect 25 is an apparatus for wireless communication at a network node, including: at least one memory; and at least one processor coupled to the at least one memory, and based at least in part on information stored in the at least one memory, the at least one processor is configured to: transmit, for a user equipment (UE), at least one downlink control information (DCI) associated with at least one downlink transmission; and receive an uplink transmission including a hybrid automatic repeat request (HARQ)-acknowledgment (ACK) codebook associated with the at least one DCI, where the uplink transmission is scrambled based on a scrambling sequence from a set of scrambling sequences, where the scrambling sequence is selected based on a mathematical operation based on a quantity of the set of scrambling sequences or a HARQ-ACK codebook size of the HARQ-ACK codebook.

Aspect 26 is the apparatus of aspect 25, where the mathematical operation is a modular operation before compression, and where the quantity of the set of scrambling sequences is equal to the HARQ-ACK codebook size of the HARQ-ACK codebook plus one.

Aspect 27 is the apparatus of aspect 25, where the at least one processor is further configured: transmit, via a radio resource control (RRC) signaling, a configuration of the set of scrambling sequences.

Aspect 28 is the apparatus of any of aspects 25, where a configuration of the set of scrambling sequences is configured without signaling.

Aspect 29 is the apparatus of aspect 25, where the at least one processor is further configured: transmit, via a radio resource control (RRC) signaling, a configuration of the set of scrambling sequences.

Aspect 30 is the apparatus of aspect 25, where a configuration of the set of scrambling sequences is configured without signaling.

Aspect 31 is a method of wireless communication for implementing any of aspects 1 to 30.

Aspect 32 is a computer-readable medium (e.g., a non-transitory computer-readable medium) storing computer executable code, the code when executed by at least one processor causes the at least one processor to implement any of aspects 1 to 30.

Aspect 33 is an apparatus comprising means for implementing any of aspects 1 to 30.

What is claimed is:

1. An apparatus for wireless communication at a user equipment (UE), comprising:
at least one memory; and
at least one processor coupled to the at least one memory, and based at least in part on information stored in the at least one memory, the at least one processor is configured to:
receive, from a network node, at least one downlink control information (DCI) associated with at least one downlink transmission; and
transmit, to the network node, an uplink transmission comprising a hybrid automatic repeat request (HARQ)-acknowledgment (ACK) codebook associated with the at least one DCI, wherein the uplink transmission is scrambled based on a HARQ-ACK codebook size of the HARQ-ACK codebook.

2. The apparatus of claim 1, wherein the uplink transmission is a physical uplink control channel (PUCCH) transmission, and wherein a PUCCH demodulation reference signal (DM-RS) associated with the PUCCH transmission is based on a size associated with the HARQ-ACK codebook.

3. The apparatus of claim 2, wherein the size associated with the HARQ-ACK codebook is mapped to a particular sequence in a set of sequences, wherein the set of sequences is associated with the PUCCH DM-RS.

4. The apparatus of claim 2, wherein the size associated with the HARQ-ACK codebook is mapped to a particular cyclic shift in a set of cyclic shifts, wherein the set of cyclic shifts is associated with the PUCCH DM-RS.

5. The apparatus of claim 2, wherein the size associated with the HARQ-ACK codebook is mapped to a particular hopping identifier (ID) in a set of hopping IDs, wherein the set of hopping IDs is associated with the PUCCH DM-RS.

6. The apparatus of claim 2, wherein the size associated with the HARQ-ACK codebook is mapped to a particular initialization identifier (ID) in a set of initialization IDs, wherein the set of initialization IDs is associated with an initialization of the PUCCH DM-RS, and wherein the initialization is further based on a time associated with the PUCCH DM-RS.

7. The apparatus of claim 1, wherein the uplink transmission is a physical uplink control channel (PUCCH) transmission without a PUCCH demodulation reference signal (DM-RS), wherein a sequence associated with the PUCCH transmission is based on a size of the HARQ-ACK codebook.

8. The apparatus of claim 1, wherein the uplink transmission is a physical uplink shared channel (PUSCH) transmission, and wherein an uplink control information (UCI) codeword associated with the PUSCH transmission that comprises the HARQ-ACK codebook is scrambled based on a scrambling sequence that depends on a size associated with the HARQ-ACK codebook.

9. The apparatus of claim 1, wherein an uplink control information (UCI) codeword associated with the uplink transmission that comprises the HARQ-ACK codebook is based on a polar codec, and wherein a cyclic redundancy check associated with the UCI codeword is scrambled based on a scrambling sequence that depends on a size associated with the HARQ-ACK codebook.

10. An apparatus for wireless communication at a user equipment (UE), comprising:
at least one memory; and
at least one processor coupled to the at least one memory, and based at least in part on information stored in the at least one memory, the at least one processor is configured to:
receive, from a network node, at least one downlink control information (DCI) associated with at least one downlink transmission; and
transmit, to the network node, an uplink transmission comprising a hybrid automatic repeat request (HARQ)-acknowledgment (ACK) codebook associated with the at least one DCI, wherein the uplink transmission is scrambled based on a scrambling sequence from a set of scrambling sequences, wherein the scrambling sequence is selected based on a mathematical operation based on a quantity of the set of scrambling sequences or a HARQ-ACK codebook size of the HARQ-ACK codebook.

11. The apparatus of claim 10, wherein the mathematical operation is a modular operation before compression, and wherein the quantity of the set of scrambling sequences is equal to the HARQ-ACK codebook size of the HARQ-ACK codebook plus one.

12. The apparatus of claim 10, wherein the at least one processor is further configured:
receive, via a radio resource control (RRC) signaling, a configuration of the set of scrambling sequences.

13. The apparatus of claim 10, wherein a configuration of the set of scrambling sequences is configured without signaling from the network node.

14. The apparatus of claim 10, wherein the at least one processor is further configured:
receive, via a radio resource control (RRC) signaling, a configuration of the set of scrambling sequences.

15. The apparatus of claim 10, wherein a configuration of the set of scrambling sequences is configured without signaling from the network node.

16. An apparatus for wireless communication at a network node, comprising:
at least one memory; and
at least one processor coupled to the at least one memory, and based at least in part on information stored in the at least one memory, the at least one processor is configured to:
transmit, for a user equipment (UE), at least one downlink control information (DCI) associated with at least one downlink transmission; and
receive an uplink transmission comprising a hybrid automatic repeat request (HARQ)-acknowledgment (ACK) codebook associated with the at least one DCI, wherein the uplink transmission is scrambled based on a HARQ-ACK codebook size of the HARQ-ACK codebook.

17. The apparatus of claim 16, wherein the uplink transmission is a physical uplink control channel (PUCCH) transmission, and wherein a PUCCH demodulation reference signal (DM-RS) associated with the PUCCH transmission is based on a size associated with the HARQ-ACK codebook.

18. The apparatus of claim 17, wherein the size associated with the HARQ-ACK codebook is mapped to a particular sequence in a set of sequences, wherein the set of sequences is associated with the PUCCH DM-RS.

19. The apparatus of claim 17, wherein the size associated with the HARQ-ACK codebook is mapped to a particular cyclic shift in a set of cyclic shifts, wherein the set of cyclic shifts is associated with the PUCCH DM-RS.

20. The apparatus of claim 17, wherein the size associated with the HARQ-ACK codebook is mapped to a particular hopping identifier (ID) in a set of hopping IDs, wherein the set of hopping IDs is associated with the PUCCH DM-RS.

21. The apparatus of claim 17, wherein the size associated with the HARQ-ACK codebook is mapped to a particular initialization identifier (ID) in a set of initialization IDs, wherein the set of initialization IDs is associated with an initialization of the PUCCH DM-RS, and wherein the initialization is further based on a time associated with the PUCCH DM-RS.

22. The apparatus of claim 16, wherein the uplink transmission is a physical uplink control channel (PUCCH) transmission without a PUCCH demodulation reference signal (DM-RS), wherein a sequence associated with the PUCCH transmission is based on a size of the HARQ-ACK codebook.

23. The apparatus of claim 16, wherein the uplink transmission is a physical uplink shared channel (PUSCH) transmission, and wherein an uplink control information (UCI) codeword associated with the PUSCH transmission that comprises the HARQ-ACK codebook is scrambled based on a scrambling sequence that depends on a size associated with the HARQ-ACK codebook.

24. The apparatus of claim 16, wherein an uplink control information (UCI) codeword associated with the uplink transmission that comprises the HARQ-ACK codebook is based on a polar codec, and wherein a cyclic redundancy check associated with the UCI codeword is scrambled based on a scrambling sequence that depends on a size associated with the HARQ-ACK codebook.

25. An apparatus for wireless communication at a network node, comprising:
at least one memory; and
at least one processor coupled to the at least one memory, and based at least in part on information stored in the at least one memory, the at least one processor is configured to:
transmit, for a user equipment (UE), at least one downlink control information (DCI) associated with at least one downlink transmission; and
receive an uplink transmission comprising a hybrid automatic repeat request (HARQ)-acknowledgment (ACK) codebook associated with the at least one DCI, wherein the uplink transmission is scrambled based on a scrambling sequence from a set of scrambling sequences, wherein the scrambling sequence is selected based on a mathematical operation based on a quantity of the set of scrambling sequences or a HARQ-ACK codebook size of the HARQ-ACK codebook.

26. The apparatus of claim 25, wherein the mathematical operation is a modular operation before compression, and wherein the quantity of the set of scrambling sequences is equal to the HARQ-ACK codebook size of the HARQ-ACK codebook plus one.

27. The apparatus of claim 25, wherein the at least one processor is further configured:
transmit, via a radio resource control (RRC) signaling, a configuration of the set of scrambling sequences.

28. The apparatus of claim 25, wherein a configuration of the set of scrambling sequences is configured without signaling.

29. The apparatus of claim 25, wherein the at least one processor is further configured:
transmit, via a radio resource control (RRC) signaling, a configuration of the set of scrambling sequences.

30. The apparatus of claim 25, wherein a configuration of the set of scrambling sequences is configured without signaling.
